(19) United States
(12) Patent Application Publication
(10) Pub. No.: US 2026/0028487 A1
(43) Pub. Date: Jan. 29, 2026

(54) HYDROPHOBIC COATING COMPOSITIONS

(71) Applicant: UNIVERSITY OF EXETER, Exeter Devon (GB)

(72) Inventors: Anna BALDYCHEVA, Devon (GB); Evgeniya KOVALSKA, Devon (GB)

(21) Appl. No.: 18/993,387

(22) PCT Filed: Jul. 6, 2023
(86) PCT No.: PCT/GB2023/051786

§ 371 Date: Jan. 10, 2025

(30) Foreign Application Priority Data
Jul. 11, 2022 (GB) 2210135.6

(51) Int. Cl. C09D 5/16; C01B 32/19; C08G 77/24; C08K 3/04; C08K 5/098; C09D 7/20; C09D 7/45; C09D 7/61; C09D 7/63; C09D 7/80; C09D 183/08

(52) U.S. Cl. CPC C09D 5/1675; C01B 32/19; C08G 77/24; C09D 7/20; C09D 7/45; C09D 7/61; C09D 7/63; C09D 7/80; C09D 183/08; C01B 2204/04; C08K 3/042; C08K 5/098; C08K 2201/011

(57) ABSTRACT

This disclosure provides for a hydrophobic coating composition containing a suspension of at least one fluorinated silane polymer and graphene in an aqueous medium and a method of preparing the hydrophobic coating composition involving the steps of a) providing a mixture of multilayer graphene, a fluorinated silane polymer and an aqueous medium; and b) subjecting the mixture to agitation.

### TECHNICAL FIELD OF THE INVENTION

The present invention relates to a hydrophobic coating composition, methods of manufacturing a hydrophobic coating composition and processes of applying hydrophobic coating compositions to an article surface.

### BACKGROUND TO THE INVENTION

Wet and windy weather contributes to the saturation of moisture on building and construction materials, and wet weather followed by cold weather leads to moisture freezing in the surface layer of such materials leading to cracking, erosion or the walls becoming icy. Additionally, the World Health Organization and the Institute of Medicine have reported that moisture levels in buildings have been determined as a negative factor influencing occupants' health. Moisture induced corrosion also impacts the building's strength, and as a result may contribute to an increase in upkeep cost or to the cost of restoration.

Hydrophobic coatings and surfaces have potential to be self-cleaning, anti-sticking, and anti-icing. A variety of techniques have been developed to prepare hydrophobic surfaces; however, many known techniques are complex, require pre-coating steps, impregnation of the hydrophobic material into the building material, formation of an integral hydrophobic compound within the building material and/or are time-consuming. Examples of such hydrophobic materials include those disclosed in CN112933983, CN106609006 and CN105968527. Known disadvantages of these materials are that they require difficult application processes such as reduced pressure, very high temperatures for drying or additional dispersion methods such as ultrasonic dispersion during surface application.

It would therefore be advantageous to provide a hydrophobic or superhydrophobic coating composition which can be easily applied by a user and does not require significant pre or post surface treatment or forced drying.

Despite the variety of products on the market for water repellent coatings there remains interest to develop hydrophobic or superhydrophobic coatings that result in a low wettability response and long-term durability whilst being cheap and easy to manufacture. It would therefore be advantageous to provide a hydrophobic or superhydrophobic coating composition with a reduced number of components and simple manufacturing steps. It would also be advantageous to provide a hydrophobic or superhydrophobic coating solution which is transparent thereby maintaining the visual effect of the materials that it is coated on to and which does not suffer from one or more of the problems of the prior art.

In addition, it would be advantageous to provide a hydrophobic or superhydrophobic coating composition which does not comprise solvents which can negatively affect the environment, i.e. they can easily be sprayed onto materials outdoors due to low risk of damaging the environment or the health of the user.

It is an aim of embodiments of the invention to overcome one or more problems of the prior art, whether expressly disclosed herein or not.

### SUMMARY OF THE INVENTION

According to a first aspect of the invention, there is provided a hydrophobic coating composition comprising a suspension of at least one fluorinated silane and graphene in an aqueous medium.

“Suspension” may be defined as a system in which solid particles are heterogeneously distributed or dispersed in a liquid.

In some embodiments, the fluorinated silane may be a compound with the general structure of (RO)₃—Si—R′-—, wherein R is an alkyl group, alkenyl group or hydrogen, R′ is a C1 to C5 hydrocarbon linkage and X is an organofluorine functional group.

In some embodiments R is alkyl or alkenyl and may comprise between 1 and 4 carbon atoms. In some embodiments, R is alkyl or alkenyl and may comprise 2, 3 or 4 carbon atoms. In some embodiments, R may be selected from ethyl, propyl or butyl. In preferred embodiments R is ethyl. In alternative embodiments the RO group may be a hydroxyl group such that R is hydrogen.

The oxygen in the RO group may be covalently bonded to the silicon in the fluorinated silane. In some embodiments all three RO groups in the fluorinated silane are the same. In alternative embodiments each RO group may be different or alternatively two may be the same and one may be different. The RO groups are advantageous because they create a polar head structure in the fluorinated silane which, in use, physically interacts with the graphene in the hydrophobic coating composition.

In some embodiments the C1 to C5 hydrocarbon linkage is a C1 to C5 alkyl linkage. In some embodiments the alkyl linkage may comprise 2 or 3 carbon atoms. In preferred embodiments the alkyl linkage may comprise 2 carbon atoms (i.e. may comprise an ethyl linkage). The C1 to C5 hydrocarbon linkage may be covalently bonded to the silicon and to the organofunctional group in the fluorinated silane.

In some embodiments the organofluorine functional group may be a fluorocarbon. In some embodiments the fluorocarbon may be saturated. In some embodiments the fluorocarbon may comprise at least 4, 5, 6, 7 or 8 carbon atoms. In some embodiments the fluorocarbon may comprise no more than 14, 13, 12 or 11 carbon atoms. In some embodiments the fluorocarbon may comprise between 4 and 14, 5 and 13, or between 6 and 12 carbon atoms. In some embodiments the fluorocarbon may comprise between 6 and 12 carbon atoms. In some embodiments the fluorocarbon may have the formula CF₃—(CF₂)ₙ wherein n is between 5 and 13, 4 and 13 or between 6 and 12. In preferred embodiments, the fluorocarbon may comprise 6, 7 or 8 carbon atoms. In some embodiments the fluorocarbon may be of the formula C₈F₁₇. The fluorocarbon chain is advantageous because the long radical chain of high energy carbon-fluorine bonds provides a hydrophobic effect on a surface to which the coating is applied to.

In some embodiments the fluorinated silane is 1H,1H,2H,2H-perfluorodecyltriethoxysilane (FDTS).

In some embodiments, the graphene is multilayer graphene. In some embodiments the multilayer graphene may comprise between 2 and 10 layers of graphene. In some embodiments the multilayer graphene may comprise 2, 3, 4, 5, 6, 7, 8, 9 or 10 layers of graphene. In some embodiments, the multilayer graphene may comprise 4, 5 or 6 layers of graphene. In some embodiments, the multilayer graphene may have an average lateral size of approximately 110 nm. The multilayer graphene may possess grain boundaries and surface defects. The use of multilayer graphene is advantageous because it has a large surface area, good hydrophobicity, and good self-assembly properties. Multilayer graphene may also be advantageous because it selectively physically interacts with the alkoxy group of the fluorinated silane to improve hydrophobic properties of the resulting composition. The multilayer graphene-silane composition results in strong affinity towards the surface that it is used on thereby improving durability of the hydrophobic coating.

In some embodiments the hydrophobic coating composition comprises at least 0.1%, 0.2%, 0.3%, 0.4% or 0.5% by weight of fluorinated silane. In some embodiments the hydrophobic coating composition comprises no more than 7%, 6%, 5%, 4% or 3% by weight of fluorinated silane. In some embodiments the hydrophobic coating composition comprises between 0.1% and 5%, 0.2% and 3% or 0.5% and 3% by weight of fluorinated silane. In some preferred embodiments the hydrophobic coating composition comprises between 0.5% and 1.5% by weight of fluorinated silane.

In some embodiments the hydrophobic coating composition comprises at least 0.1%, 0.2%, 0.3%, 0.4%, 0.5%, 0.6%, 0.7%, 0.8%, 0.9% or 1% by weight of graphene. In some embodiments the hydrophobic coating composition comprises no more than 10%, 9%, 8%, 7%, 6%, 5.5%, 5%, 4.5% or 4% by weight of graphene. In some embodiments the hydrophobic coating composition comprises between 0.1% and 9%, 0.1% and 8%, 0.1% and 7%, 0.1% and 6%, 0.1% and 5%, 0.2% and 4.5%, 0.3% and 4%, 0.4% and 3.5%, 0.5% and 3%, 4% and 8%, 4% and 7%, 4% and 6% or 3% and 5% by weight of graphene.

In some embodiments, the hydrophobic coating composition comprises at least 60%, 65%, 70%, 75%, 80%, 85%, 90%, 95%, 96%, 97%, 98% or at least 99% aqueous medium. In some embodiments the aqueous medium is water. In some embodiments the hydrophobic coating composition preferably consists of water and no other solvent.

In some embodiments the hydrophobic coating composition comprises an aqueous medium comprising water and at least one additional cosolvent. In some embodiments the cosolvent is a polar solvent. In some embodiments the polar solvent is an alcohol, which may be selected from methanol, ethanol, propanol, isopropanol or butanol, or any combination thereof. In some embodiments, the cosolvent is isopropanol. In some embodiments, the hydrophobic coating composition comprises at least 75%, 80%, 85%, 90%, 85%, 96%, 97%, 98% or at least 99% of the water and cosolvent mixture. In some embodiments the ratio of water to cosolvent is between 1:5 and 5:1. In some embodiments the ratio of water to cosolvent is between 1:4 and 5:1, 1:3 and 5:1, 1:2 and 5:1 or 1:1 and 5:1. In some embodiments the ratio of water to cosolvent is between 1.1:1 and 4.5:1, 1.5:1 and 4:1 or between 2:1 and 3.5:1. In preferred embodiments when the hydrophobic coating composition comprises a water and isopropanol mixture, the ratio of water to isopropanol is around 3:1.

In some embodiments, the hydrophobic coating composition comprises a surfactant. In some embodiments, the surfactant is an anionic surfactant. In some embodiments the surfactant is a salt of a fatty acid. In some embodiments the surfactant is a salt of a bile acid. In preferred embodiments the surfactant is a cholate, such as sodium cholate. In some embodiments the concentration of surfactant is at least 0.05%, 0.1%, 0.2%, 0.3%, 0.4% or 0.5% by weight in the final composition. In some embodiments the concentration of surfactant is no more than 5%, 4.5%, 4%, 3.5% or 3% by weight in the final composition. In some embodiments the concentration of surfactant is between 0.05% and 5%, 0.1% and 4.5%, 0.2% and 4% or 0.5% and 3% by weight in the final composition. In some embodiments the concentration of surfactant is between 0.1% and 1% by weight in the final composition. In some embodiments, the hydrophobic composition comprises a surfactant and the aqueous medium is a mixture comprising water and a cosolvent. In some embodiments, the hydrophobic composition comprises a surfactant and the aqueous medium is water. In some embodiments the hydrophobic coating composition comprises a surfactant and comprises between 0.5% and 4% by weight graphene. In some embodiments the hydrophobic coating composition comprises a surfactant and comprises between 0.5% and 3.5%, 1% and 3%, 1.5% and 3%, 2% and 2.75% or between 2% and 2.5% by weight graphene. In some embodiments the hydrophobic coating composition comprises a surfactant and comprises no more than 3.5%, 3%, 2.9%, 2.8%, 2.7%, 2.6% or no more than 2.5% by weight graphene. The presence of a surfactant in the composition is advantageous because the surfactant ensures that the multilayer graphene is stabilised such that it does not re-agglomerate. The presence of a surfactant is also advantageous as it stabilises the suspension such that the suspension can be made ahead of use and stored for a period of time.

In some embodiments the hydrophobic coating composition is surfactant-free. In some embodiments, the hydrophobic composition is surfactant-free and the aqueous medium is water. In some embodiments, the hydrophobic composition is surfactant-free and the aqueous medium is a mixture of water and a cosolvent. In some embodiments, the hydrophobic composition is surfactant-free and the aqueous medium is a mixture of water and isopropanol. In some embodiments the hydrophobic coating composition is surfactant-free and comprises at least 2.5%, 2.6%, 2.7%, 2.8%, 2.9%, 3% or at least 3.5% by weight graphene. In some embodiments the hydrophobic coating composition is surfactant-free and comprises at least 4%, 4.5%, 5%, 5.5% or at least 6% by weight graphene. In some embodiments the hydrophobic coating composition is surfactant-free and comprises no more than 10%, 9%, 8% or 7% by weight graphene. In some embodiments the hydrophobic coating composition is surfactant-free and comprises between 3.5% and 8%, 4% and 7% or between 4% and 6% by weight graphene. A surfactant-free composition comprising at least 3.5% by weight graphene may be advantageous because the composition improves the hydrophobicity of the surface of an article and the composition comprising no surfactant may be cheaper. The surfactant-free composition may also be advantageous because it may be easier to manufacture on a large scale as the surfactants can be difficult to handle due to surfactants often being high viscosity or solid-state components. The presence of isopropanol in a surfactant-free hydrophobic coating composition is advantageous because it results in the hydrophobic coating composition only requiring additional mixing by shaking well, to disperse the suspension before applying it to the surface of interest.

According to a second aspect of the invention, there is provided a method of preparing a hydrophobic coating suspension according to the first aspect of the invention comprising the steps a) providing a mixture of multilayer graphene, a fluorinated silane and an aqueous medium; and b) subjecting the mixture to agitation to form a homogenous dispersion.

In some embodiments, step a) comprises providing multilayer graphene, fluorinated silane and an aqueous medium and mixing the ingredients to form the mixture. In some embodiments, step a) comprises the addition of multilayer graphene to a mixture of fluorinated silane and an aqueous medium.

The multilayer graphene may be made in a step before step a), which may comprise making multilayer graphene from graphite, such as, for example by way of a liquid-phase exfoliation method performed on graphite. In some embodiments, the liquid-phase exfoliation, method may comprise high speed mixing of graphite, preferably graphite flakes, a surfactant and an aqueous medium. In some embodiments, the aqueous medium is water. In some embodiments the aqueous medium is a mixture of water and a cosolvent. In some embodiments the aqueous medium is a mixture of water and an alcohol. In some embodiments the aqueous medium is a mixture of water and isopropanol. In some embodiments, the liquid-phase exfoliation method may comprise high speed mixing of graphite, preferably graphite flakes, and a mixture of water with isopropanol, and may also be surfactant-free. The liquid-phase exfoliation method may result in the formation of sheets of multilayer graphene.

In some embodiments the concentration of surfactant is no more than 5%, 4.5%, 4%, 3.5% or 3% by weight in the final composition. In some embodiments the concentration of surfactant is between 0.05% and 5%, 0.1% and 4.5%, 0.2% and 4% or 0.5% and 3% by weight in the final composition. In some embodiments, the concentration of surfactant is between 0.1% and 1% by weight in the final composition. In some embodiments, the surfactant is an anionic surfactant. In some embodiments the surfactant is a bile acid salt. In some embodiments the surfactant is a cholate such as sodium cholate. Sodium cholate is an anionic surfactant comprising three hydroxy groups located on a steroid ring and one carboxylic group at the terminus of the molecular structure, and there are no definitive lipophilic or hydrophilic regions in the molecule. Cholate can be easily removed by dialysis. The surfactant may stabilize the sheets of multilayer graphene which prevents the multilayer graphene from re-agglomerating. The production of multilayer graphene from graphite may further comprise a centrifugation step after the exfoliation step. The centrifugation step may separate the multilayer graphene from heavier, unexfoliated graphite. The centrifugation step may be advantageous because the heavier, unexfoliated graphite does not remain dispersed in the suspension as effectively as the lighter multilayer graphene and therefore would lead to separation or deposit formation in the hydrophobic coating suspension.

In some embodiments the liquid-phase exfoliation step may not comprise a surfactant. In some embodiments the liquid-phase exfoliation step may not comprise a surfactant and may comprise water and isopropanol as the aqueous medium. The surfactant-free production of multilayer graphene from graphite in water/isopropanol medium may be advantageous because the method of graphene production is cheaper, faster (contains only one step) and contamination-free. The presence of an organic counterpart in the aqueous medium may stabilize the sheets of multilayer graphene which also prevents the multilayer graphene from re-agglomerating.

In some embodiments the liquid-phase exfoliation step may comprise high speed mixing for at least 10, 20, 30, 40, 50, 60, 70, 80, 90, 100, 110, 120 or 130 minutes. In some embodiments the liquid-phase exfoliation step may comprise high speed mixing at a stirring rate of at least 3000, 3250, 3500, 3750 or 4000 rpm. In some embodiments the liquid-phase exfoliation step may comprise high speed mixing at a stirring rate of no more than 9000, 8500, 8000, 7500 or 7000 rpm. In some embodiments the liquid-phase exfoliation step may comprise high speed mixing at a stirring rate of between 4000 and 9000, 3500 and 8000 or 3000 and 7000 rpm.

In some embodiments, the production of multilayer graphene from graphite may further comprise a settling step after the liquid-phase exfoliation step. This settling step may allow the multilayer graphene to separate in the suspension from heavier, unexfoliated graphite. The heavier, unexfoliated graphite does not remain dispersed in the suspension and will precipitate so the only supernatant comprising lighter graphene sheets will be used for hydrophobic coating suspension.

In some embodiments, the concentration of the fluorinated silane is at least 0.01%, 0.05%, 0.1%, 0.2%, 0.3%, 0.4% or 0.5% by weight. In some embodiments the concentration of the fluorinated silane is no more than 7%, 6%, 5%, 4.5%, 4%, 3.5% or 3% by weight. In some embodiments the concentration of the fluorinated silane is between 0.1% and 5%, 0.2% and 4.5%, 0.3 and 4%, 0.4% and 3.5% or 0.5% and 3% by weight. In preferred embodiments the concentration of the fluorinated silane is between 0.5% and 1.5% by weight.

In some embodiments the concentration of the multilayer graphene is at least 0.05%, 0.1%, 0.2%, 0.3%, 0.4%, 0.5%, 0.6%, 0.7%, 0.8%, 0.9% or 1% by weight. In some embodiments the concentration of the multilayer graphene is no more than 10%, 9%, 8%, 7%, 6%, 5%, 4.5%, 4%, 3.5%, 3%, 2.5% or no more than 2% by weight. In some embodiments the concentration of the multilayer graphene is between 0.1% and 5%, 0.2% and 5%, 0.3% and 5%, 0.5% and 5% or 1% and 5% by weight. In some embodiments the concentration of the multilayer graphene is between 3% and 8%, 4% and 8% or 4.5% and 7% by weight. In some embodiments the concentration of the multilayer graphene is between 1.5% and 3% by weight, such as between 1.5% and 2.5% by weight, and such concentrations are particularly useful for providing superhydrophobic properties to the compositions, when applied to the surface of an article.

In some embodiments, the hydrophobic coating composition comprises at least 75%, 80%, 85%, 90%, 85%, 96%, 97%, 98% or at least 99% aqueous medium. In some embodiments, the aqueous medium may be water. In alternative embodiments, hydrophobic coating composition may comprise water and one or more other cosolvents, such as an alcohol, which may be selected from methanol, ethanol, propanol and isopropanol, preferably isopropanol.

Step b) may be carried out with any suitable mixing process. In preferred embodiments, the agitation step comprises ultrasound sonication.

In some embodiments, step b) may comprise subjecting the mixture to ultrasound sonication after the completion of step a). In some embodiments. the ultrasound sonication may be carried out for no more than 150, 120, 110, 100, 90, 80, 70 or 60 minutes. In some embodiments, the ultrasound sonication may be carried out for at least 5, 6, 7, 8, 9 or 10 minutes. In some embodiments the ultrasound sonication may be carried out for between 5 and 120, 6 and 110 minutes, 7 and 100 minutes, 8 and 90 minutes, 9 and 80 minutes or 10 and 70 minutes. In some embodiments, the ultrasound sonication may be carried out for between 10 and 30 minutes.

In some embodiments, after step b) an additional mixing step may be required to re-homogenise the hydrophobic composition should it separate upon standing. This additional mixing step can be a mechanical mixing step. In some embodiments, this additional mixing step can comprise shaking the hydrophobic composition well.

According to a third aspect of the invention there is provided a process of coating an article comprising the steps of a) depositing a hydrophobic coating composition of the first aspect of the invention onto a surface of the article; and b) drying the coating composition to form a coating on the surface.

In some embodiments, the article may be a construction material. In some embodiments the construction material may be any porous construction material. In some embodiments, the construction material may comprise a component of a wall or is a wall. In some embodiments, the construction material may be a brick or block. In some embodiments, the brick may be clay, sand and lime or fly ash. In some embodiments, the construction material may be concrete and may be a concrete block or brick. In some embodiments the article may be a roof such as a concrete roof, a terracotta roof or a painted roof. In some embodiments the article may be a rendered building surface such as wood or a cladding material. In some embodiments, the article may be a flexible material. The flexible material may be one or more materials selected from the group comprising leather, synthetic textiles, smart textiles (i.e., textile materials containing electronic components), wool, cotton and any combination thereof. In some embodiments the article may be an open electrode or any open electronic circuit wherein open means non-encapsulated or without a jacket or protective packaging. In some embodiments the article may be an electronic device such as a phone or a computer.

Step a) comprises a method of depositing the hydrophobic coating composition to the surface of an article. In some embodiments the method of application may be drop casting. In other embodiments, the method of application is spraying. In other embodiments, the method of application is mechanical application through the use of a roller.

In some embodiments, the hydrophobic coating composition is applied to the surface of an article at a temperature of at least 5° C., 7° C., 9° C., 11° C., 13° C. or 15° C. In some embodiments, the hydrophobic coating composition may be sprayed on the surface of the article at a temperature of no more than 70° C., 65° C., 60° C., 55° C. or 50° C. In some embodiments, the hydrophobic coating composition may be sprayed on the surface of the article at a temperature between 5° C. and 70° C., 7° C. and 65° C., 9° C. and 60° C., 11° C. and 55° C. or 13° C. and 50° C.

In preferred embodiments the hydrophobic coating composition may be sprayed on the surface of the article at a temperature of between 10° C. and 40° C. In some embodiments the hydrophobic coating composition may be sprayed at room temperature or ambient temperature. In some embodiments the volume of the hydrophobic coating composition to be sprayed may be at least 100, 150, 200, 250, 300 or 350 mL per 1000 cm². In some embodiments the volume of the hydrophobic coating composition to be sprayed may be no more than 3000, 2750, 2500, 2250 or 2000 mL per cm². In some embodiments the volume of the hydrophobic coating composition to be sprayed may be between 100 and 2000 mL per 1000 cm² or between 250 and 2500 mL per cm² or between 100 and 3000 mL per cm².

Step b) may comprise drying the hydrophobic coating composition on the surface at a temperature of at least 5° C., 7° C., 9° C., 11° C., 13° C. or 15° C. In some embodiments, the hydrophobic coating composition may be dried on the surface of the article at a temperature of no more than 70° C., 65° C., 60° C., 55° C. or 50° C. In some embodiments, the hydrophobic coating composition may be dried on the surface of the article at a temperature between 5° C. and 70° C., 7° C. and 65° C., 9° C. and 60° C., 11° C. and 55° C. or 13° C. and 50° C. In preferred embodiments the hydrophobic coating composition may be dried on the surface of the article at a temperature between 10° C. and 40° C. The drying step may be completed at ambient temperature such that no forced drying is required.

In some embodiments, the drying step may be performed for at least 1, 5, 10 or 15 minutes. In some embodiments, the drying step may be performed for no more than 60, 55, 50, 45 or 40 minutes. In some embodiments the drying step may be performed for between 1 and 60 minutes, 5 and 55 minutes, 10 and 50 minutes or 15 and 45 minutes. In some embodiments, the drying step may be performed for between 15 and 35 minutes.

The process of depositing the hydrophobic solution on the surface may not require an additional surface treatment step either before step a), during step a), before step b), during step b) or after step b). This process of application comprising step a), step b) and no additional surface treatment step is advantageous because it is easier for the user to apply the coating to the surface compared to other surface coatings that require force drying for example at high temperatures. This widens the applications of the surface coating as it can be easily applied to large surface areas without a requirement to force dry the coating.

According to a fourth aspect of the invention, there is provided an article comprising a hydrophobic coating composition according to the first aspect of the invention. The article of the fourth aspect of the invention may be made by a process according to the third aspect of the invention. The article of the fourth aspect of the invention may be made by a method according to the second aspect of the invention.

The article with the hydrophobic coating may demonstrate superior hydrophobic performance. Hydrophobic performance can be measured by measuring the water contact angle. The “contact angle of water” or the “water contact angle” is defined as the angle between the edge of a static droplet of water and a flat horizontal surface of a solid where the droplet of water is placed. The higher the contact angle, the higher the hydrophobic response between the liquid and the surface. If a liquid completely covers the surface and forms a film, the contact angle is zero degrees (0°). If the contact angle is greater than 90° then the surface is called “hydrophobic”. If the contact angle is up to at least or greater than 150° then such coatings are referred to as “superhydrophobic” coatings. The application process according to the third aspect of the invention, using the hydrophobic coating solution of the first aspect of the invention, is advantageous because it may result in superhydrophobic performance. In some embodiments, the hydrophobic coating maintains superhydrophobic performance for at least 1, 2, 3, 4, 5 or 6 months. In some embodiments, the hydrophobic coating maintains superhydrophobic performance for at least 9, 10, 11 or 12 months.

According to a fifth aspect of the invention there is provided a hydrophobic coating composition comprising a suspension of at least one non-fluorinated silane and graphene in an aqueous medium.

The non-fluorinated silane may be fluorine free or essentially fluorine free. The hydrophobic coating composition may be according to any embodiment of the first aspect of the invention with the exception that the hydrophobic coating composition of the fifth aspect of the invention comprises a non-fluorinated silane instead of a fluorinated silane.

The hydrophobic coating composition may include any of the components of the first aspect of the invention (save that the fluorinated silane of the first aspect is replaced with the non-fluorinated silane of the fifth aspect).

In some embodiments, the silane may be a compound with the general structure of (RO)₃—Si—R′—Y wherein R is an alkyl group, alkenyl group or hydrogen, R′ is a C1 to C5 hydrocarbon linkage and Y is a functional group which does not comprise fluorine. R may be according to any embodiment of the first aspect of the invention. R′ may be according to any embodiment of the first aspect of the invention. Y may be selected from the group consisting of: a non-fluorine halogen, a non-fluorine organohalogen, a hydrocarbon, an alkyl, an aryl, an alkenyl, an alkynyl, an alkylaryl, an alkoxy, an aryloxy, an amine, a second silane and hydrogen or any combination thereof.

According to a sixth aspect of the invention, there is provided a method of preparing a hydrophobic coating suspension according to the fifth aspect of the invention comprising the steps a) providing a mixture of multilayer graphene, a silane and an aqueous medium; and b) subjecting the mixture to agitation to form a homogenous dispersion.

The method of the sixth aspect of the invention may be according to any embodiment of the second aspect of the invention wherein the hydrophobic coating of the first aspect of the invention is replaced with the hydrophobic coating composition of the fifth aspect of the invention.

According to a seventh aspect of the invention there is provided a process of coating an article comprising the steps of a) depositing a hydrophobic coating composition of the fifth aspect of the invention onto a surface of the article; and b) drying the coating composition to form a coating on the surface.

According to an eighth aspect of the invention, there is provided an article comprising a hydrophobic coating composition according to the fifth aspect of the invention. The article of the eighth aspect of the invention may be made by made by a process according to the seventh aspect of the invention. The article of the eighth aspect of the invention may be made by a method according to the sixth aspect of the invention.

### DETAILED DESCRIPTION OF THE INVENTION

In order that the invention may be more clearly understood embodiments thereof will now be described, by way of example only, with reference to the accompanying drawings, of which:

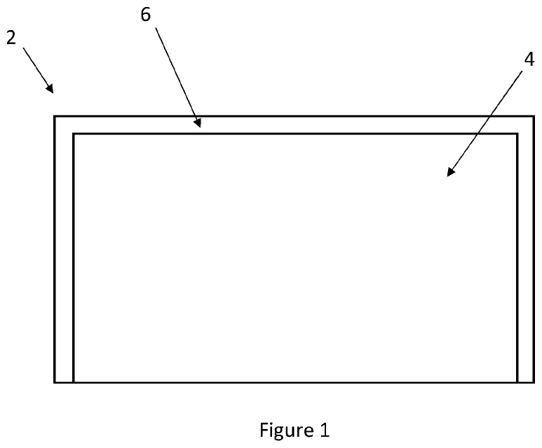

FIG. 1 illustrates a cross-sectional view of an embodiment of an article of the invention in the form of a brick coated with a hydrophobic coating of the invention which is applied to the top surface and the side surfaces.

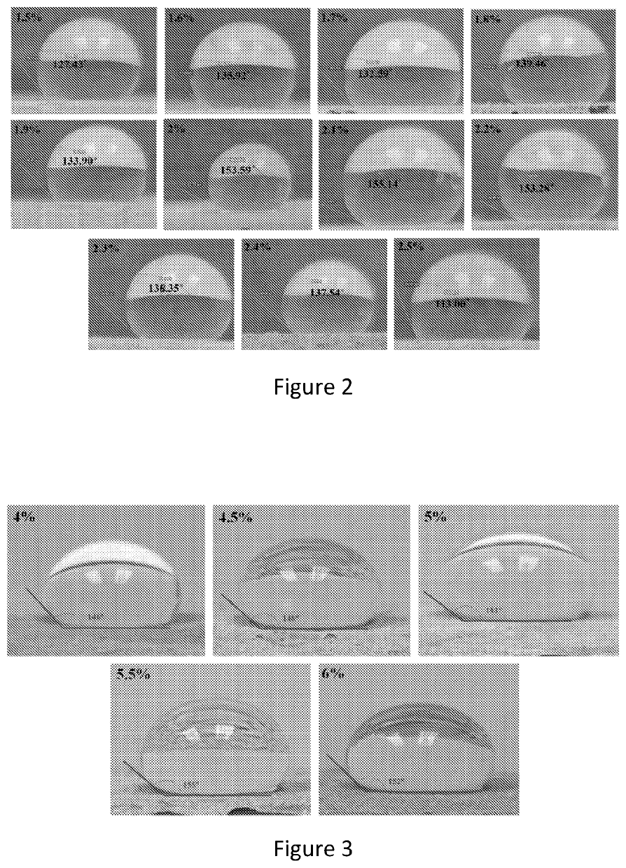

FIG. 2 illustrates the measurement of the water contact angle of a droplet of tap water, after 1 month, on a concrete cube wherein each concrete cube is coated with a surfactant-based hydrophobic coating composition of the invention comprising 1.5%, 1.6%, 1.7% 1.8%, 1.9%, 2.0%, 2.1%, 2.2%, 2.3%, 2.4% or 2.5% by weight multilayer graphene and 1% by weight silane according to formulations C to M in table 1.

FIG. 3 illustrates the measurement of the water contact angle of a droplet of tap water, after 1 day and after 1 month, on a concrete cube wherein each concrete cube is coated with a surfactant-free hydrophobic coating composition of the invention comprising 4.0%, 4.5%, 5.0% 5.5% or 6.0% by weight multilayer graphene and 1% by weight silane according to formulations Q to U in table 2.

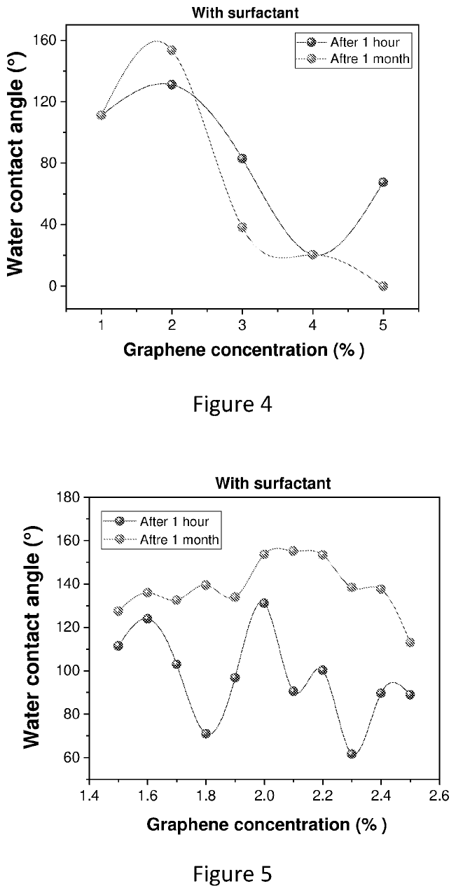

FIG. 4 illustrates the water contact angle of a concrete cube coated with a surfactant-based hydrophobic coating composition of the invention wherein each concrete cube is coated with a hydrophobic coating of the invention comprising 1%, 2%, 3%, 4% or 5% by weight multilayer graphene and 1% by weight silane according to formulations B, H, N, O and P in table 1 wherein the water contact angle is measured 1 hour after application and again 1 month after application.

FIG. 5 illustrates the water contact angle of a concrete cube coated in a surfactant-based hydrophobic coating composition of the invention comprising 1.5% to 2.5% by weight of multilayer graphene and 1% by weight silane according to formulations C to M in table 1 wherein the water contact angle is measured 1 hour after application and again 1 month after application.

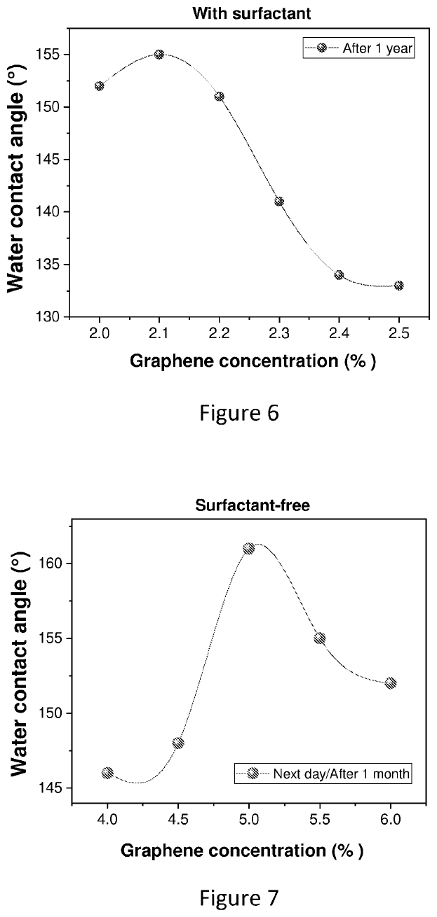

FIG. 6 illustrates the water contact angle of a concrete cube coated in a surfactant-based hydrophobic coating composition of the invention comprising 2.0% to 2.5% by weight of multilayer graphene and 1% by weight silane according to formulations H to M in table 1 wherein the water contact angle is measured 1 year after application.

FIG. 7 illustrates the water contact angle of a concrete cube coated in a surfactant-free hydrophobic coating composition of the invention comprising 4.0% to 6.0% by weight of multilayer graphene and 1% by weight silane according to formulations Q to U in table 2 wherein the water contact angle is measured 1 month after application.

FIG. 1 shows an embodiment of a coated article of the invention in the form of a coated concrete brick (2). The coated brick comprises a brick body (4) on which is coated an embodiment of the coating composition of the first aspect of the invention in the form of a coating (6). The coating comprises multilayer graphene, a fluorinated silane and an aqueous medium. The fluorinated silane is 1H,1H,2H,2H-perfluorodecyltriethoxysilane and the aqueous medium is water. Formulations of the hydrophobic coating compositions as formulations A to U which were applied to the brick (2) are exemplified below in table 1 and table 2.

### Example 1

### Production of a Surfactant-Based Hydrophobic Coating Composition of the Invention

An embodiment of the second aspect of the invention describes a method for preparing the hydrophobic coating of the first aspect of the invention as set out below. A first embodiment of the second aspect of the invention included the following steps. First, a liquid-phase exfoliation method was used to produce multilayer graphene. The liquid-phase exfoliation step comprised combining 15 mg/ml of graphite flakes and 5 mg/ml of sodium cholate surfactant with a suitable amount (800 ml) of deionized water. The mixture was stirred with a high shear laboratory mixer for example a L5M, Silverson Machines Ltd., UK mixer with a 32 mm diameter rotor head. The mixture was stirred for 60 minutes at 4500 rpm. The liquid-phase exfoliation leads to the Van der Waals forces between the graphite layers in the graphite flakes breaking thereby obtaining thin sheets of multilayer graphene. The sodium cholate surfactant stabilises the thin sheets of multilayer graphene such that they do not re-agglomerate. The liquid-phase exfoliation was followed by centrifugation for 100 minutes at 1000 rpm such that residual graphite flakes are removed from the multilayer graphene mixture. The multilayer graphene produced comprises 2-10 layers.

The multilayer graphene was then added to the fluorinated silane which in this example was 1H,1H,2H,2H-perfluorodecyltriethoxysilane. 1% by weight of 1H,1H,2H,2H-perfluorodecyltriethoxysilane was added to a portion of the multilayer graphene such that the amount of multilayer graphene in the final product is between 1% and 5% by weight according to formulations B to P as shown in table 1. Formulation A is included in table 1 as a control fluid which does not comprise multilayer graphene (0%).

The hydrophobic coating compositions of the invention (formulations B to P) and the control formulation (A) were then mixed by ultrasound sonication for 20 minutes such that the resulting product is a suspension.

TABLE 1

| | Multilayer | | |
|---|---|---|---|
| Formulation | graphene, % wt. | Silane, % wt. | Other ingredients |
| A (control) | 0 | 1 | Remainder water and |
| | | | surfactant |
| B | 1.0 | 1 | Remainder water and |
| | | | surfactant |
| C | 1.5 | 1 | Remainder water and |
| | | | surfactant |
| D | 1.6 | 1 | Remainder water and |
| | | | surfactant |
| E | 1.7 | 1 | Remainder water and |
| | | | surfactant |
| F | 1.8 | 1 | Remainder water and |
| | | | surfactant |
| G | 1.9 | 1 | Remainder water and |
| | | | surfactant |
| H | 2.0 | 1 | Remainder water and |
| | | | surfactant |
| I | 2.1 | 1 | Remainder water and |
| | | | surfactant |
| J | 2.2 | 1 | Remainder water and |
| | | | surfactant |
| K | 2.3 | 1 | Remainder water and |
| | | | surfactant |
| L | 2.4 | 1 | Remainder water and |
| | | | surfactant |
| M | 2.5 | 1 | Remainder water and |
| | | | surfactant |
| N | 3.0 | 1 | Remainder water and |
| | | | surfactant |
| O | 4.0 | 1 | Remainder water and |
| | | | surfactant |
| P | 5.0 | 1 | Remainder water and |
| | | | surfactant |

### Example 2

### Production of a Surfactant-Free Hydrophobic Coating Composition of the Invention

A second embodiment of the second aspect of the invention, wherein the hydrophobic composition is a surfactant-free composition, comprises the following steps. First, surfactant-free liquid-phase exfoliation method was used to produce multilayer graphene. The liquid-phase exfoliation step comprised combining 6 mg/ml of graphite flakes with a suitable amount of deionized water/isopropanol solution e.g. 600 ml solution of DI water with isopropanol (ratio DI water: isopropanol is 3:1). The mixture was stirred with a high shear laboratory mixer for example a L5M, Silverson Machines Ltd., UK mixer with a 32 mm diameter rotor head. The mixture was stirred for 120 minutes at 7000 rpm. The liquid-phase exfoliation in the presence of organic components leads to the Van der Waals forces between the graphite layers in the graphite flakes breaking thereby obtaining highly concentrated multilayer graphene dispersion. The organic molecules in the solution stabilise the multilayer graphene sheets for a shorter period in comparison to a surfactant-based procedure. The liquid-phase exfoliation was followed by a settling step at room temperature wherein the heavier residual graphene flakes separate from the multilayer graphene solution. The decantation of the upper level of final dispersion after several hours of rest in the air avoids additional centrifugation. The residual graphite flakes were left in the precipitate and were removed. The multilayer graphene produced comprises 2-10 layers.

The multilayer graphene was then added to the fluorinated silane which in this example was 1H,1H,2H,2H-perfluorodecyltriethoxysilane. 1% by weight of 1H,1H,2H,2H-perfluorodecyltriethoxysilane was added to a portion of the multilayer graphene such that the amount of multilayer graphene in the final product was between 4% and 6% by weight. The inventive formulations comprising between 4% and 6% by weight of multilayer graphene are shown in table 2 as formulations Q to U.

The hydrophobic coating compositions of the invention were then mixed by ultrasound sonication for 20 minutes such that the resulting product is a suspension.

TABLE 2

| | Multilayer | | | |
|---|---|---|---|---|
| | graphene, | Silane, | Surfactant, | |
| Formulation | % wt. | % wt. | % wt | Other ingredients |
| Q | 4.0 | 1 | 0 | Remainder water |
| | | | | and isopropanol |
| R | 4.5 | 1 | 0 | Remainder water |
| | | | | and isopropanol |
| S | 5.0 | 1 | 0 | Remainder water |
| | | | | and isopropanol |
| T | 5.5 | 1 | 0 | Remainder water |
| | | | | and isopropanol |
| U | 6.0 | 1 | 0 | Remainder water |
| | | | | and isopropanol |

### Example 3

### Method of Application of the Hydrophobic Coating compositions of Examples 1 and 2 Onto Articles

The embodiments of the hydrophobic coating compositions of Formulations B to U according to the first aspect of the invention, and the control Formulation A were then each sprayed onto a surface of a concrete brick (2) at room temperature to form a hydrophobic coating (6), as shown in FIG. 1. The coating (6) was then dried at room temperature for 20 to 30 minutes. The concrete brick (2) was made using Blue Circle General Purpose Cement and tap water at a concentration ratio of 2:1 by weight. The prepared concrete bricks (2) were then dried overnight.

Formulations A to U were each sprayed onto a concrete brick (2) at ambient temperature and dried at ambient temperature for 30 minutes.

The water contact angle of the hydrophobically coated concrete bricks (2) was then analysed with an Inkscape© software. Such analysis for formulations C to M in table 1 and Q to U in table 2 are shown in FIGS. 2 and 3 respectively wherein the angle between the edge of the water droplet and the horizontal concrete surface coated with formulations C to U was measured, thereby giving the water contact angle.

The water contact angle for surfactant-free formulations B, H, N, O and M comprising 1%, 2%, 3, %, 4% and 5% by weight multilayer graphene and 1% by weight silane, was measured 1 hour after coating. The concrete bricks (2) with the hydrophobic coating (6) comprising formulations B, H, N, O and P were stored at ambient conditions for one month and the water contact angle was measured at one month after application. FIG. 4 graphically illustrates the results for the water contact angle of the concrete bricks (2) individually coated with each of formulations B to D where the water contact angle was measured 1 hour after application of the formulations and again 1 month after application of the formulations.

The water contact angle on the concrete bricks (2) coated with the hydrophobic coating (6) formulations C to M, comprising 1.5%, 1.6%, 1.7%, 1.8%, 1.9%, 2.0%, 2.1%, 2.2%, 2.3%, 2.4% and 2.5% by weight multilayer graphene and 1% by weight silane, were measured 1 hour after application. The concrete bricks (2) were then stored for one month and the water contact angle was measured at one month after application. The results of these experiments are illustrated graphically in FIG. 5.

The concrete bricks (2) with the hydrophobic coating (6) comprising formulations H to M, comprising 2.0%, 2.1%, 2.2%, 2.3%, 2.4% and 2.5% by weight multilayer graphene and 1% by weight silane, were stored for one year and the water contact angle was measured at one year after application. The results of these experiments are illustrated graphically in FIG. 6.

The concrete bricks (2) with the hydrophobic coating (6) comprising formulations Q to U, comprising 4.0%, 4.5%, 5.0%, 5.5% and 6.0% by weight multilayer graphene and 1% by weight silane, were stored for one month and the water contact angle was measured 1 day after application and one month after application. The results of these experiments are illustrated graphically in FIG. 7.

All hydrophobic coating compositions (6) were transparent when applied to the concrete bricks (2).

### Results

The results of the above tests demonstrate that the concentration of the multilayer graphene in the hydrophobic coating composition impacts the hydrophobic performance of the coating after spraying and over time. High water contact angles correlate to good water repellence. Formulation A, comprising no multilayer graphene, resulted in a water contact angle of approximately 35° when tested 1 hour after coating. Control formulation A was therefore not hydrophobic or superhydrophobic. Formulations B to N of the invention, which contain between 1% by weight and 3% by weight multilayer graphene in a surfactant based hydrophobic composition and formulation Q to U comprising between 4% and 6% by weight multilayer graphene in a surfactant-free composition all showed hydrophobic or superhydrophobic performance suggesting the presence of multilayer graphene at concentrations between 1% and 6% by weight is key to superior hydrophobic performance compared to formulations that do not comprise multilayer graphene.

The formulations H, I and J which contained 2.0%, 2.1% and 2.2% by weight multilayer graphene showed significantly improved hydrophobic performance than the multilayer graphene free formulation (control formulation A) with water contact angles of 154°, 155° and 153° respectively when measured 1 month after applications, therefore formulations comprising between 2% and 2.2% by weight multilayer graphene are superhydrophobic. Formulations S, T and U, comprising 5.0%, 5.5% and 6.0% by weight multilayer graphene also showed superhydrophobic performance with measured contact angle results of 161°, 155° and 152° respectively, when measured one day after coating and one month after coating.

Formulations comprising between 1% and 1.9% by weight multilayer graphene (formulations B to G) showed good hydrophobic performance and good durability with water contact angles of between 110° and 140° when measured one month after coating.

Formulations H, I, J, K, L and M comprising between 2%-2.5% by weight graphene resulted in superior hydrophobic performance even when tested 1 year after coating with water contact angle results between 132° and 155°. Formulations H, I and J, comprising 2.0%, 2.1% and 2.2% by weight of multilayer graphene, demonstrate superhydrophobic performance when tested as a coating on concrete 1 year after coating, with water contact angle results of 152°, 155° and 150° respectively, showing a high level of durability of hydrophobic coating compositions of these formulations over the period of at least 1 year. Formulations comprising between 4% and 6% by weight graphene (prepared using surfactant-free exfoliation) and comprising a water and isopropanol mixture, as exemplified by formulations Q and U in table 2, show superior hydrophobic performance with water contact angles between 146° and 161°. In particular, formulations with 5.0%, 5.5% and 6.0% by weight of multilayer graphene maintain superhydrophobic performance 1 year after coating, with water contact angles of 161°, 155° and 152° respectively. In the application, the hydrophobic performance shown by formulations comprising between 1% to 6% by weight multilayer graphene and the good durability translates to good surface protection of materials from water, dust, ice, moss, mould and fungus and contributes to the maintenance of good outer appearance in wall stone constructions.

The above embodiment is/embodiments are described by way of example only. Many variations are possible without departing from the scope of the invention as defined in the appended claims.

1. A hydrophobic coating composition comprising a suspension of at least one fluorinated silane and graphene in an aqueous medium.

2. A hydrophobic coating composition according to claim 1 wherein the fluorinated silane is a compound with the general formula of (RO)₃—Si—R′—X, wherein R is an alkyl group, alkenyl group or hydrogen, R′ is a C1 to C5 hydrocarbon linkage and X is an organofluorine functional group, and is preferably 1H,1H,2H,2H-perfluorodecyltriethoxysilane.

3. A hydrophobic coating composition according to claim 1 wherein the graphene is multilayer graphene comprising between 2 and 10 layers of graphene.

4. A hydrophobic coating composition according to claim 1 wherein the amount of fluorinated silane is at least 0.1% by weight.

5. A hydrophobic coating composition according to claim 1 wherein the amount of graphene is between 1% and 6% by weight.

6. A hydrophobic coating composition according to claim 1 wherein the aqueous medium is water.

7. A hydrophobic coating composition according to claim 1 wherein the amount of aqueous medium is between 65% and 99%.

8. A hydrophobic coating composition according to claim 1 comprising a cosolvent which is preferably a polar solvent and is more preferably isopropanol.

9. A hydrophobic coating composition according to claim 8 wherein the amount of isopropanol is between 0% and 40% by weight.

10. A hydrophobic coating composition according to claim 1 comprising graphene in an amount of less than 4% by weight and further comprising a surfactant.

11. A hydrophobic coating composition according to claim 10 wherein the surfactant is a salt of a fatty acid, preferably a bile acid.

12. A hydrophobic coating composition according to claim 10 wherein the amount of surfactant is no more than 2% by weight.

13. A method of preparing a hydrophobic coating composition according to claim 1, comprising the steps of a) providing a mixture of multilayer graphene, a fluorinated silane and an aqueous medium; and b) subjecting the mixture to agitation.

14. A method of preparing a hydrophobic coating composition according to claim 13 wherein there is a step before step a) of making multilayer graphene from graphite.

15. A method of preparing a hydrophobic coating composition according to claim 14 wherein the multilayer graphene is prepared using a liquid-phase exfoliation method on graphite.

16. A method of preparing a hydrophobic coating composition according to claim 14 wherein the graphite is mixed with a surfactant.

17. A method of preparing a hydrophobic coating composition according to claim 16 wherein the surfactant is sodium cholate.

18. A method of preparing a hydrophobic coating composition according to claim 13 wherein the graphite is mixed with water and at least one other solvent.

19. A method of preparing a hydrophobic coating composition according to claim 13 wherein step a) comprises mixing multilayer graphene with the fluorinated silane in an aqueous medium.

20. A method of preparing a hydrophobic coating composition according to claim 13 wherein step b) comprises mixing the mixture resulting from step a) using ultrasound sonication to form a homogeneous dispersion.

21. A process of coating an article comprising the steps of a) depositing a hydrophobic coating composition of claim 1 on a surface of the article; and b) drying the hydrophobic coating composition to form a coating on the surface.

22. A process of coating an article according to claim 21 wherein the temperature of step a) is between 20° C. and 40° C.

23. A process of coating an article according to claim 21 wherein step a) comprises spraying the hydrophobic coating composition onto the surface of an article and wherein the volume of hydrophobic composition that is sprayed is between 0.25 mL and 3 mL per cm² of the surface of the article.

24. A process of coating an article according to claim 21 wherein the temperature of step b) is at ambient temperature such as between 15° C. and 40° C.

25. A process of coating an article according to claim 21 wherein step b) comprises drying the hydrophobic coating composition for between 20 and 30 minutes.

26. A process of coating an article according to claim 21 wherein the article is selected from a group comprising building or construction materials, textiles, electronics and electronic textiles.

27. An article comprising a hydrophobic coating of a composition according to claim 1 coated on at least one surface thereof.
